(19) United States
(12) Patent Application Publication
(10) Pub. No.: US 2005/0038561 A1
(43) Pub. Date: Feb. 17, 2005

(54) Method, system and computer-readable medium for operating a robot in an AMHS

(76) Inventor: Kai-Chi Lin, Hsin-Chu City (TW)

Correspondence Address: LOWE HAUPTMAN GILMAN & BERNER, LLP;Suite 310, 1700 Diagonal Road, Alexandria, VA, 22314, US

(21) Appl. No.: 10/638,392

(22) Filed: Aug. 12, 2003

(51) Int. Cl. G06F 19/00

(52) U.S. Cl. 700/245

(57) ABSTRACT

The present invention provides a method, system and computer-readable medium for operating a robot in an automatic material handling system (AMHS). The method includes indicating a token to a first port for pre-setting a first corresponding job item of the first port to be processed, processing a second job item with the robot while the second job item locates in a different section to the first job item but in a same section to the robot and of waiting for being processed to a same section to the first job item, processing the first job item with the robot, and moving the token off from the first port.

### BACKGROUND OF THE INVENTION

1. Field of the Invention

This invention generally relates to the field of an automatic material handling system (AMHS). More particularly, the present invention relates to a method, system and computer-readable medium for operating a robot in an AMHS.

2. Description of the Prior Art

Manufacturing wafers in a wafer factory includes not only many complex procedures but also rework procedures. Hence, under a normal manufacturing situation, wafers stored and transported in the wafer factory are much quite often. However, an AMHS provides storage and auto-transporting functionalities, wherein a stocker is used to store wafers waiting to be processed, a rail-guided vehicle (RGV) is utilized to transport the wafers from a far end stocker to a near end stocker in order to run them through the manufacturing procedures. In a multistory AMHS, some stockers connect different floors and therefore have the function of (a) a transporting elevator; (b) upper floor storage, input, output, car output, and car input; (c) lower floor storage, input, output, car output, and car input. Since a robot needs to bring the transporting, inputting and outputting into full play in such heavy loading, the efficient operating method for the robot becomes the first important consideration in an AMHS.

As shown in FIG. 1, robot-moving paths generated from a robot applying a first-in-first-out (FIFO) method is illustrated. A stocker 100 is a four floors building, its third and fourth floors are defined as an upper section 110, and its first and second floors are defined as a lower section 120. O₁˜O₄, O₇, O₈ represent job items waiting for outputting; I₅, I₆, I₁₃, I₁₄ represent job items waiting for inputting; CI₉, CI₁₀, CI₁₅, CI₁₆ represent job items inputted from a RGV; CO_{11, CO}₁₂, CO₁₇, CO₁₈ represent job items outputted to a RGV. Wherein, the index words are the order of corresponding commands lining in a command queue (not shown). Paths 1˜35 are the moving order of the robot. Since applying the FIFO method, the robot (not shown) moves a job item O₁ to the output of the upper section 110 as path 1; moving to a job item O₂ as path 2 and moving it to the output of the lower section 120 as path 3; moving to a job item O₃ as path 4 and moving it to the output of the upper section 110 as path 5; moving to a job item O₄ as path 6 and moving it to the output of the lower section 120 as path 7; moving to a job item I₅ as path 8 and moving it to store as path 9; moving to a job item I₆ as path 10 and moving it to store as path 11; and similarly, other paths can be found in this way. As shown in FIG. 1, the robot totally has 35 moves including 17 moves taking nothing (as those dash lines). The 17 moves consist of 14 moves crossing a different section and 3 moves in a same section. Therefore, the FIFO method makes the robot have many moves taking nothing and further consumes system resource. Also, the robot concentrates on processing those first job items and hence causes those later job items to wait for a long time. As mentioned above, the entire operating efficiency is poor and the resource distribution is inappropriate.

As shown in FIG. 2, robot-moving paths generated from a robot applying a priority method is illustrated. In this example, the priority setting is a car>output>input, and the illustration signs except paths are the same as those in FIG. 1. Since applying the priority method, the robot (not shown) moves a job item CI₉ to store as path 1; moving to a job item CI₁₀ as path 2 and moving it to store as path 3; moving to a job item CO₁₁ as path 4 and moving it to the car of the upper section 110 as path 5; moving to a job item CO₁₂ as path 6 and moving it to the car of the lower section 120 as path 7; moving to a job item CI₁₅ as path 8 and moving it to store as path 9; moving to a job item CI₁₆ as path 10 and moving it to store as path 11; and similarly, other paths can be found in this way. As shown in FIG. 2, the robot totally has 35 moves including 17 moves taking nothing (as those dash lines). The 17 moves consist of 15 moves crossing a different section and 2 moves in a same section. Therefore, the priority method might occupy the robot by those higher priority job items; on the contrary, those lower priority job items can use the robot only during the intervals between the higher priority job items. In a word, the priority method might cause an unbalance during the multistory stocker operation; and even in a high transporting situation, the robot only focuses on processing some particular ports and ignores other ports.

In view of the drawbacks mentioned with the prior art of AMHS, there is a continued need to develop a new and improved method and system that overcomes the disadvantages associated with the prior art of AMHS. The advantages of this invention are that it solves the problems mentioned above.

### SUMMARY OF THE INVENTION

In accordance with the present invention, a method, system for operating a robot in an AMHS substantially obviates one or more of the problems resulted from the limitations and disadvantages of the prior art mentioned in the background.

Accordingly, one object of the present invention is to provide a token cycle to equally distribute the use of the robot in an AMHS.

Another object is to provide a robot moving logic to reduce the robot moves taking nothing.

Yet another object is to provide a robot operating system of an AMHS to improve the entire operating efficiency.

Still another object is to provide a computer-readable medium encoded with computer program code for operating a robot in an AMHS to equally distribute resource, reduce resource consumption, and improve the entire operating efficiency.

According to the aforementioned objects, the present invention provides a method for operating a robot in an AMHS. The method includes indicating a token to a first port for pre-setting a first corresponding job item of the first port to be processed, processing a second job item with the robot while the second job item locates in a different section to the first job item but in a same section to the robot and of waiting for being processed to a same section to the first job item, processing the first job item with the robot, and moving the token off from the first port.

The present invention further discloses a computer-readable medium encoded with computer program code for operating a robot in an AMHS. The program code causes a computer to execute a method including the aforementioned steps of indicating a token to a first port for pre-setting a first corresponding job item of the first port to be processed; processing a second job item with the robot while the second job item locates in a different section to the first job item but in a same section to the robot and of waiting for being processed to a same section to the first job item; processing the first job item with the robot; and moving the token off from the first port. By doing so, the program code encoded within the computer-readable medium causes the computer to execute the method for operating a robot in an AMHS.

The present invention further discloses a robot operating system of an AMHS. The system includes a plurality of ports; a token cycling among the plurality of ports to indicate one of the pluralities of ports as a predetermined priority port; and a robot moving among the plurality of ports to process a plurality of corresponding job items of the plurality of ports, wherein, while the robot locates in a different section to a corresponding priority job item of the predetermined priority port, the robot processes a corresponding job item of a port being in a same section to the robot before processing the corresponding priority job item of the predetermined priority port.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates robot-moving paths generated from a robot applying a well-known FIFO method;

FIG. 2 illustrates robot-moving paths generated from a robot applying a well-known priority method;

FIG. 3 illustrates a token cycle embodiment in accordance with the present invention;

FIG. 4 illustrates a robot-moving logic method in accordance with the present invention;

FIG. 5A illustrates robot-moving paths while a robot locates in the same section to the token starting from a car output;

FIG. 5B illustrates robot-moving paths while a robot locates in a different section to the token starting from a car output;

FIG. 5C illustrates robot-moving paths while a robot locates in the same section to the token starting from a car input;

FIG. 5D illustrates robot-moving paths while a robot locates in a different section to the token starting from a car input; and

FIG. 6 illustrates robot-moving paths generated from a robot applying a token cycle and robot-moving logic in accordance with the present invention.

### DESCRIPTION OF THE PREFERRED EMBODIMENT

Some embodiments of the invention will now be described in greater detail. Nevertheless, it should be noted that the present invention can be practiced in a wide range of other embodiments besides those explicitly described, and the scope of the present invention is expressly not limited except as specified in the accompanying claims.

Moreover, some irrelevant details are not drawn in order to make the illustrations concise and to provide a clear description for easily understanding the present invention.

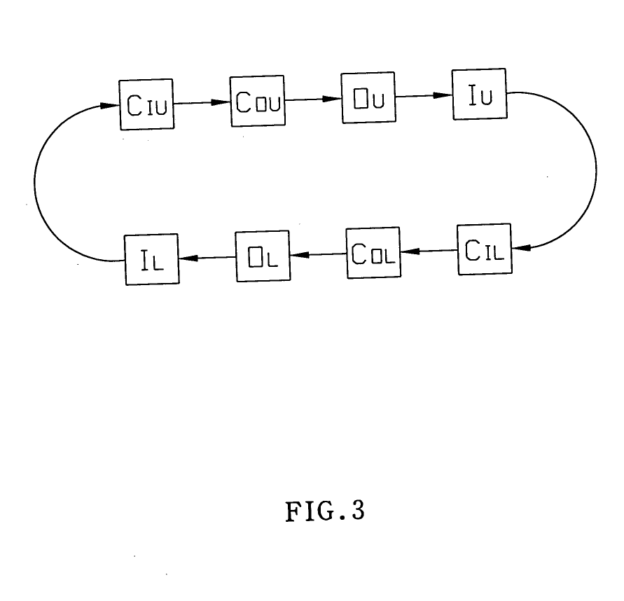

As shown in FIG. 3, a token cycle embodiment in accordance with the present invention is illustrated. A token (not shown) cycles from a first section car input (C_{IU}) through a first section car output (C_{OU}), a first section output (O_{U}), a first section input (I_{U}), a second section car input (C_{IL}), a second section car output (C_{OL}), a second section output (O_{L}) to a second section input (I_{L}), and cycles until all job items being processed. Wherein, the token represents the right of requesting robot service; that is, while the token cycles to a port, the port can request the robot to process a corresponding job item of the port, such as moving a job item from a car input, moving a job item to a car output, moving a job item to an output, and moving a job item from an input. And then, the token moves to a next port while the corresponding job item is processed. However, the token directly moves to the next port while the port to which the token cycles has no corresponding job item (also defined as an empty job item). For example, while the token cycles to the C_{OU}, the robot moving a corresponding job item to the C_{OU}, and then the token cycles to the O_{U}. While the O_{U} has no corresponding job item, the token directly cycles to the I_{U}. By doing so, a higher priority job item is still processed in advance by defining a higher priority port ahead of a lower priority port. Moreover, the higher priority port cannot occupy the robot.

Besides, in an emergency mode, i.e. cars traffic jam or a stocker is going to be full, the token cycle can be suitably adjusted, i.e. by prioritizing the car port and/or output, to improve the efficiency of a stocker operation.

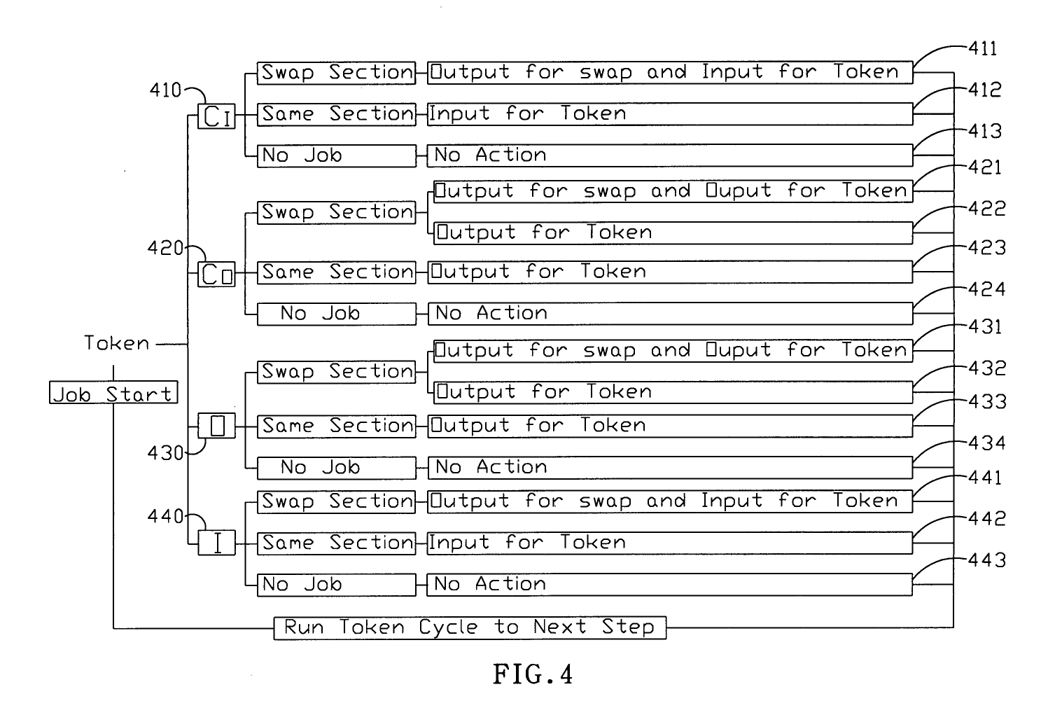

As shown in FIG. 4, a robot moving logic embodiment using the token cycle in accordance with the present invention is illustrated. C_{I} 410 represents a car input; C_{O} 420 represents a car output; O 430 represents an output; and I 440 represents an input. Swap section means the robot and the corresponding job item are in a different section. Same section means the robot and the corresponding job item are in the same section. While a token runs to the C_{I} 410 and in the swap section status, in step 411, the robot outputs a job item which exists and waits for outputting to the output of the C_{I} 410 section, and then inputs the corresponding job item from the C_{I} 410. While the token runs to the C_{I} 410 and in the same section status, in step 412, the robot inputs the corresponding job item from the C_{I} 410. While the token runs to the C_{I} 410 and there is no corresponding job item (i.e. an empty job item), the token directly cycles to the next port as shown in step 413.

While a token runs to the C_{O} 420 and in the swap section status, in step 421, the robot outputs a job item which exists and waits for outputting to the output of the C_{O} 420 section, and then outputs the corresponding job item to the C_{O} 420. While the token runs to the C_{O} 420 and in the same section status, in step 423, the robot outputs the corresponding job item to the C_{O} 420. While the token runs to the C_{O} 420 and there is no corresponding job item (i.e. an empty job item), the token directly cycles to the next port as shown in step 424.

While a token runs to the O 430 and in the swap section status, in step 431, the robot outputs a job item which exists and waits for outputting to the output of the O 430 section, and then outputs the corresponding job item to the O 430. While the token runs to the O 430 and in the same section status, in step 433, the robot outputs the corresponding job item to the O 430. While the token runs to the O 430 and there is no corresponding job item (i.e. an empty job item), the token directly cycles to the next port as shown in step 434.

While a token runs to the I 440 and in the swap section status, in step 441, the robot outputs a job item which exists and waits for outputting to the output of the I 440 section, and then inputs the corresponding job item from the I 440. While the token runs to the I 440 and in the same section status, in step 442, the robot inputs the corresponding job item from the I 440. While the token runs to the I 440 and there is no corresponding job item (i.e. an empty job item), the token directly cycles to the next port as shown in step 443. Briefly, while the token indicates to a port queuing several corresponding job items, the robot processes the first received one.

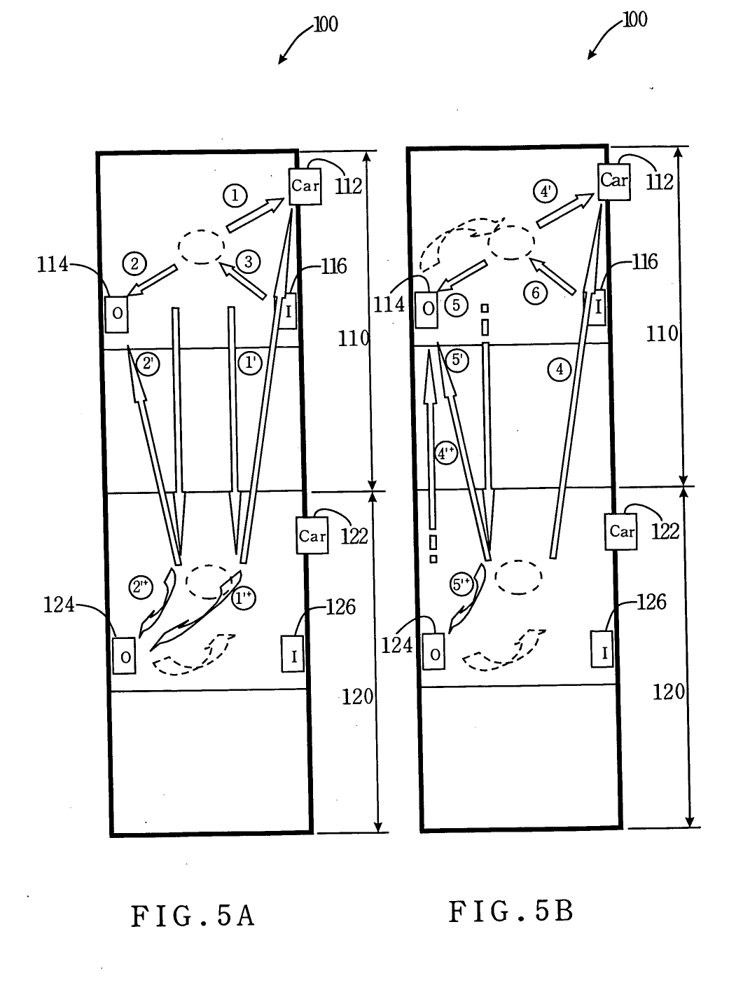

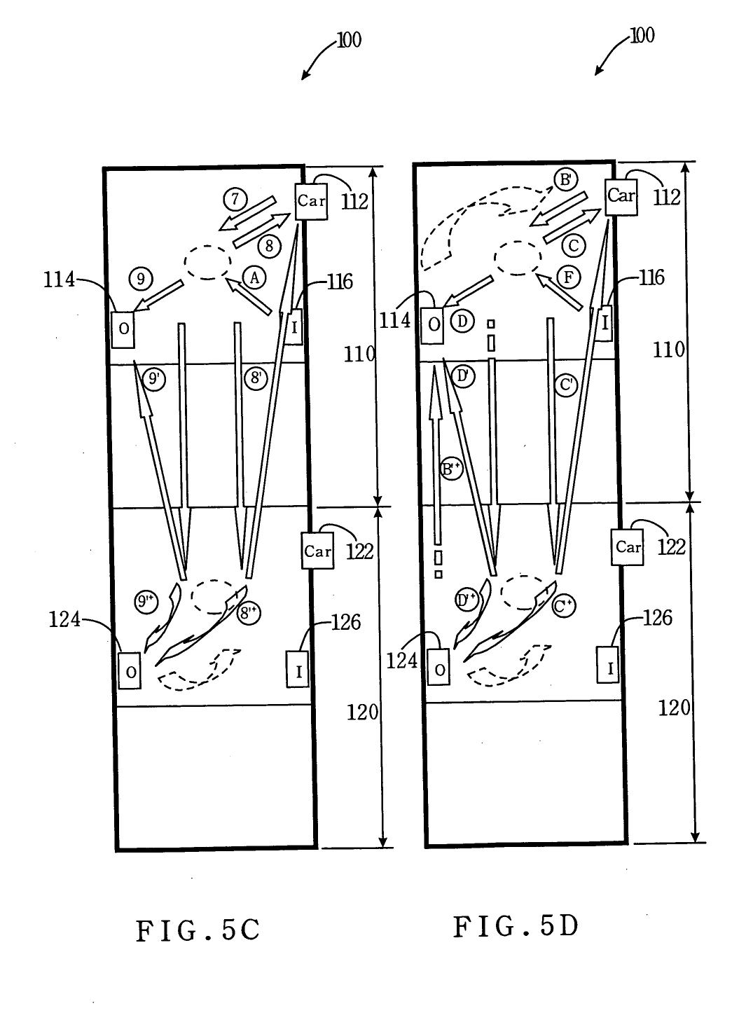

Referring to FIG. 5A, a robot (not shown) and a token (not shown) both locate in an upper section 110. Wherein, the token cycling sequence is from a car 112 input port through a car 112 output port, an output port 114 to an input port 116. The token runs to the car 112 output port. While a corresponding job item of the car 112 output port also locates in the upper section 110, the robot directly outputs the corresponding job item to the car 112 output port as path 1; however, while the corresponding job item locates in a lower section 120, the robot can first output a job item existing and waiting for outputting to the port 124 of the lower section 120 as path 1′+ before outputting the corresponding job item to the car 112 output port as path 1′. By doing so, a reduction in the robot's moves is achieved. Subsequently, the token runs to the output port 114. While a corresponding job item of the output port 114 also locates in the upper section 110, the robot directly outputs the corresponding job item to the output port 114 as path 2; yet, while the corresponding job item locates in a lower section 120, the robot can first output a job item existing and waiting for outputting to the port 124 of the lower section 120 as path 2′+ before outputting the corresponding job item to the output port 114 as path 2′. Whereby, a reduction in the robot's moves is achieved. Then, the token runs to the input port 116. The robot directly inputs the corresponding job item from the input port 116 as path 3.

Referring to FIG. 5B, a robot (not shown) locates in a lower section 120 but a token (not shown) locates in an upper section 110. Wherein, the token cycling is the same sequence as those described in FIG. 5A. The token runs to the car 112 output port. While the corresponding job item of the car 112 output port and the robot both locate in the lower section 110, the robot directly outputs the corresponding job item to the car 112 output port as path 4; however, while the corresponding job item locates in the upper section 110, the robot can first output a job item existing and waiting for outputting to the port 114 of the upper section 110 as path 4′+ before outputting the corresponding job item to the car 112 output port as path 4′. By doing so, a reduction in the robot's moves is achieved. After this step, the robot locates in the upper section 110. Subsequently, the token runs to the output port 114. While a corresponding job item of the output port 114 also locates in the upper section 110, the robot directly outputs the corresponding job item to the output port 114 as path 5; yet, while the corresponding job item locates in the lower section 120, the robot can first outputs a job item existing and waiting for outputting to the port 124 of the lower section 120 as path 5′+ before outputting the corresponding job item to the output port 114 as path 5′. Whereby, a reduction in the robot's moves is achieved. Then, the token runs to the input port 116. The robot directly inputs the corresponding job item from the input port 116 as path 6.

Referring to FIG. 5C, a robot (not shown) and a token (not shown) are both located in the upper section 110. Wherein, the token cycling is the same sequence as those described in FIG. 5A. The token runs to the car 112 input port. The robot directly inputs the corresponding job item from the car 112 input port as path 7. Similarly, the other paths, such as path 8, 8′+, 8′, 9, 9′+, 9′, and A, are generated in the same way described in FIG. 5A.

Referring to FIG. 5D, a robot (not shown) locates in a lower section 120 but a token (not shown) locates in an upper section 110. Wherein, the token cycling is the same sequence as those described in FIG. 5A. The token runs to the car 112 input port. The robot can first outputs a job item existing and waiting for outputting to the port 114 of the upper section 110 as path B′+ before inputting the corresponding job item from the car 112 input port as path B′. By doing so, a reduction in the robot's moves is achieved. After this step, the robot locates in the upper section 110. Then, the token runs to the car 112 output port. While the corresponding job item of the car 112 output port and the robot both locate in the upper section 110, the robot directly outputs the corresponding job item to the car 112 output port as path C; however, while the corresponding job item locates in the lower section 120, the robot can first outputs a job item existing and waiting for outputting to the port 124 of the lower section 120 as path C′+ before outputting the corresponding job item to the car 112 output port as path C′. By doing so, a reduction in the robot's moves is achieved. After this step, the robot still locates in the upper section 110. Similarly, the other paths, such as path D, D′+, D′, and F, are generated in the same way described in FIG. 5B.

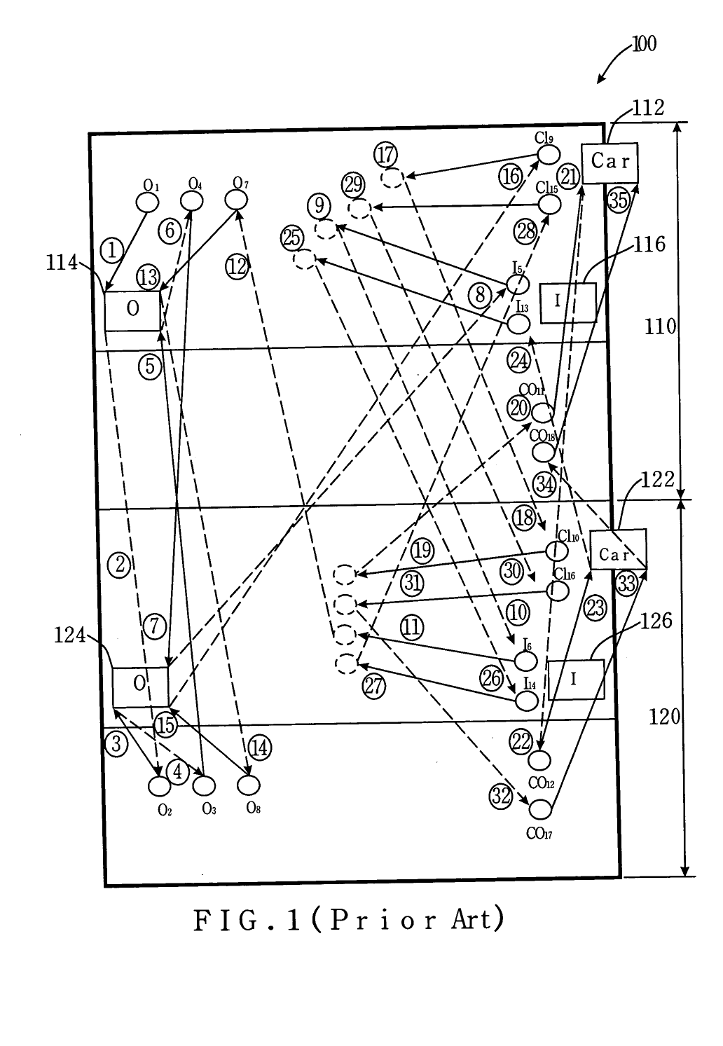

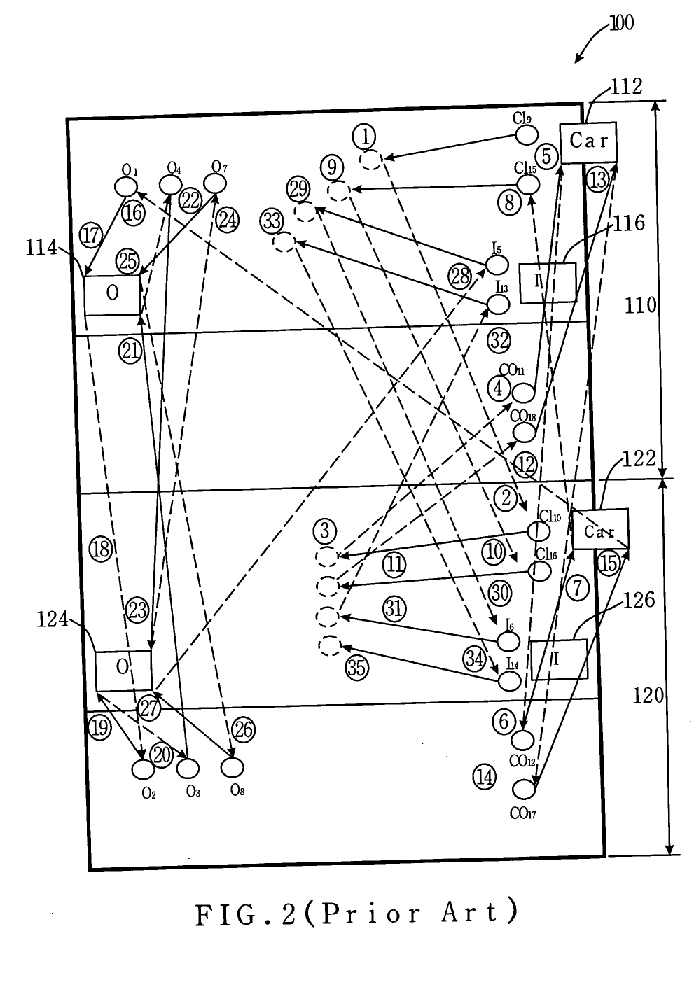

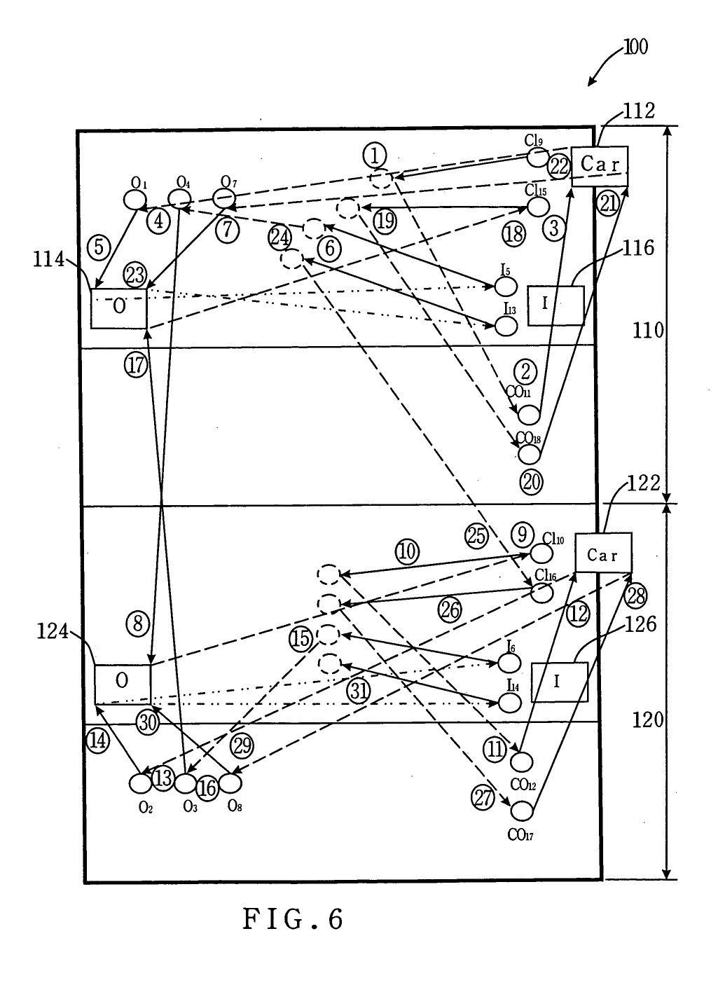

As shown in FIG. 6, robot-moving paths generated from a robot applying the token cycle and the robot-moving logic in accordance with the present invention is illustrated. In the present example, the token cycling sequence is from an upper section 110 car 112 input through an upper section 110 car 112 output, an upper section 110 output 114, an upper section 110 input 116, a lower section 120 car 122 input, a lower section 120 car 122 output, a lower section 120 output 124 to a lower section input 126. Moreover, the illustrated signs except the paths are the same as those described in FIG. 1.

Since the token (not shown) starts from the upper section 110 car 112 input, the robot (not shown) moves a job item CI₉ from the car 112 input to store as path 1. Then, the token runs to the upper section 110 car 112 output. The robot moves to a job item CO₁₁ as path 2 and outputs it to the car 112 output as path 3. Next, the token runs to the upper section 110 output 114. The robot moves to a job item O₁ as path 4 and outputs it to the output 114 as path 5. Subsequently, the token runs to the upper section 110 input 116. The robot moves to a job item I₅ (actually, the robot does not move since the output is just beside the input) and inputs it to store as path 6.

After that, the token runs to the lower section 120 car 122 input. In order to avoid moving and taking nothing, the robot first moves to a job item O₄ as path 7 and outputs it to the lower section 120 output 124 as path 8. Then, the robot moves to a job item C₁₀ as path 9 and inputs it from the car 112 input as path 10. Next, the token runs to the lower section 120 car 122 output. The robot moves to a job item CO₁₂ as path 11 and outputs it to the car 122 output as path 12. Subsequently, the token runs to the lower section 120 output 124. The robot moves to a job item O₂ as path 13 and outputs it to the output 124 as path 14. Later, the token runs to the lower section 120 input 126. The robot moves to a job item I₆ (actually, the robot does not move since the output is just beside the input) and inputs it to store as path 15.

Subsequently, the token cycles back to the upper section 110 car 112 input. To avoid moving and taking nothing, the robot moves to a job item O₃ as path 16 and outputs it to the upper section 110 output 114 as path 17. Then, the robot moves to a job item CI₁₅ as path 18 and inputs it from the car 112 input as path 19. Next, the token runs to the upper section 110 car 112 output. The robot moves to a job item CO₁₈ as path 20 and outputs it to the car 122 output as path 21. After, the token runs to the upper section 110 output 114. The robot moves to a job item O₇ as path 22 and outputs it to the output 114 as path 23. Later, the token runs to the upper section 110 input 116. The robot moves to a job item I₁₃ (actually, the robot does not move since the output is just beside the input) and inputs it to store as path 24.

After that, the token runs to the lower section 120 car 122 input again. Since there is no job item in the upper section 110 output 114, the robot directly moves to a job item CI₁₆ as path 25 and inputs it from the car 112 input as path 26. Next, the token runs to the lower section 120 car 122 output. The robot moves to a job item CO₁₇ as path 27 and outputs it to the car 122 output as path 28. Subsequently, the token runs to the lower section 120 output 124. The robot moves to a job item O₈ as path 29 and outputs it to the output 124 as path 30. Later, the token runs to the lower section 120 input 126. The robot moves to a job item I₁₄ (actually, the robot does not move since the output is just beside the input) and inputs it to store as path 31.

According to the description mentioned above, the robot totally has 31 moves including 13 moves and taking nothing (as those dash lines). The 13 moves consist of 1 move crossing a different section and 12 moves in a same section.

TABLE 1
Robot moving frequency

| | | Move Taking Nothing | | | |
|---|---|---|---|---|---|
| | Job Item | Diff. Sec. | Same Sec. | Sub-total | Total |
| FIFO | 18 | 14 | 3 | 17 | 35 |
| Priority | 18 | 15 | 2 | 17 | 35 |
| Token | 18 | 1 | 12 | 13 | 31 |

Unit: time

Comparing the token method in accordance with the present invention with the FIFO and the priority methods, the robot moving frequencies are respectively recorded in Table 1. Wherein, the token method saves 4 inputting moves than the two aforementioned methods. Due to inputting a job item from the input port after just finishing outputting a job item to the output port, the robot operates much more efficiently. Moreover, the example of the present invention has only 1 move taking nothing that is far less than the two methods do.

TABLE 2
Robot moving time

| | O₁ | O₂ | O₃ | O₄ | O₇ | O₈ | I₅ | I₆ | I₁₃ | I₁₄ | CI₉ | CI₁₀ | CI₁₅ | CI₁₆ | CO₁₁ | CO₁₂ | CO₁₇ | CO₁₈ |
|---|---|---|---|---|---|---|---|---|---|---|---|---|---|---|---|---|---|---|
| FIFO | 15 | 60 | 105 | 150 | 285 | 330 | 195 | 240 | 555 | 600 | 375 | 420 | 645 | 690 | 465 | 510 | 720 | 765 |
| Priority | 375 | 420 | 465 | 510 | 555 | 600 | 645 | 690 | 735 | 780 | 15 | 60 | 195 | 240 | 105 | 150 | 330 | 285 |
| Token | 75 | 225 | 285 | 135 | 375 | 495 | 90 | 240 | 390 | 510 | 15 | 165 | 315 | 435 | 45 | 195 | 465 | 345 |

Unit: second

Comparing the token method with the FIFO and the priority method, the robot moving times are respectively recorded in Table 2. Assuming the robot takes 15 seconds on moving in the same section and 30 seconds on moving in the different section. Wherein, the FIFO method totally takes 765 seconds on processing the job items from O₁ to CO₁₈ in proper order; the priority method totally takes 780 seconds on processing the job items from CI₉ to I₁₄ according to the priority order; and the token method takes only 510 seconds on processing the job items from CI₉ to I₁₄.

TABLE 3
Robot moving distance

| | O₁ | O₂ | O₃ | O₄ | O₇ | O₈ | I₅ | I₆ | I₁₃ | I₁₄ | CI₉ | CI₁₀ | CI₁₅ | CI₁₆ | CO₁₁ | CO₁₂ | CO₁₇ | CO₁₈ |
|---|---|---|---|---|---|---|---|---|---|---|---|---|---|---|---|---|---|---|
| FIFO | 3 | 13 | 13 | 13 | 13 | 13 | 13 | 13 | 8 | 13 | 20 | 10 | 20 | 10 | 15 | 20 | 8 | 10 |
| Priority | 8 | 13 | 13 | 13 | 13 | 13 | 13 | 13 | 13 | 13 | 5 | 10 | 15 | 10 | 15 | 20 | 20 | 15 |
| Token | 8 | 8 | 13 | 13 | 8 | 8 | 3 | 3 | 3 | 3 | 5 | 10 | 10 | 10 | 8 | 8 | 8 | 8 |

Unit: meter

As for the distances of the robot moves, the assumed data is respectively recorded in Table 3. Wherein, assuming there are 3 meters for the robot to move a job item from an input/output port to a shelf, 5 meters for the robot to move the job item from the shelf to a car, and 3 and 5 meters for the robot to move the job item in the same section and in the different section respectively. Statistically, the robot using the FIFO method totally moves 228 meters, another one using the priority method moves 235 meters, and the other one using the token method in accordance with the present invention only moves 137 meters.

It should be understood that the assumed data listed above is only to show the advantages of the present invention in order to provide a clear and concise comparison with the prior art methods, but not to limit the real improvements of the present invention.

As mentioned earlier, the present invention further discloses a computer-readable medium encoded with computer program code for operating a robot in an AMHS. The program code causes a computer to execute a method including the aforementioned token cycle shown in FIG. 3 and the steps 411˜413, 421˜424, 431˜434 and 441˜443 shown in FIG. 4. For example, the indicating a token procedure, the output for swap and car input for token procedure (step 411), the car input for token procedure (step 412), the output for swap and car output for token procedure (step 421), the car output for token procedure (step 422, 423), the output for swap and output for token procedure (step 431), the output for token procedure (step 432, 433), the output for swap and input for token procedure (step 441), the input for token procedure (step 442) and the no action produce (step 413, 424, 434 and 443). Moreover, the robot operating judgments and flows shown in FIGS. 5A˜5D and FIG. 6 are also included. By doing so, the program code encoded within the computer-readable medium causes the computer to execute a method for operating a robot in an AMHS

Although specific embodiments have been illustrated and described, it will be obvious to those skilled in the art that various modifications may be made without departing from what is intended to be limited solely by the appended claims.

1. A method for operating a robot in an automatic material handling system (AMHS), said method comprising:
indicating a token to a first port, wherein said token pre-sets a first job item of said first port to be processed;
processing a second job item with said robot while said second job item locates in a different section to said first job item but in a same section to said robot and of waiting for being processed to a same section to said first job item;
processing said first job item with said robot; and
moving said token off from said first port.

2. The method according to claim 1, wherein said second job item is a corresponding job item of a second port differing from said first port.

3. The method according to claim 1, wherein said second job item is processed by said robot while said first job item exists.

4. The method according to claim 1, wherein said second job item includes an empty job item.

5. A computer-readable medium encoded with computer program code for operating a robot in an automatic material handling system (AMHS), the program code causing a computer to execute a method comprising:
indicating a token to a first port, wherein said token pre-sets a first job item of said first port to be processed;
processing a second job item with said robot while said second job item locates in a different section to said first job item but in a same section to said robot and of waiting for being processed to a same section to said first job item;
processing said first job item with said robot; and
moving said token off from said first port.

6. The medium according to claim 5, wherein said second job item is a corresponding job item of a second port differing from said first port.

7. The medium according to claim 5, wherein said second job item is processed by said robot while said first job item exists.

8. The medium according to claim 5, wherein said second job item includes an empty job item.

9. A robot operating system of a automatic material handling system, comprising:
a plurality of ports;
a token cycling among said plurality of ports to indicate one of said plurality of ports as a predetermined priority port; and
a robot moving among said plurality of ports to process a plurality of corresponding job items of said plurality of ports;
wherein, while said robot locates in a different section to a corresponding priority job item of said predetermined priority port, said robot processes a corresponding job item of a port being in a same section to said robot before processing said corresponding priority job item of said predetermined priority port.

10. The system according to claim 9, wherein said plurality of ports includes locating in a plurality of floors.

11. The system according to claim 10, wherein said robot includes moving among said plurality of floors to process said plurality of job items.

12. The system according to claim 9, wherein said port differs from said predetermined priority port.

13. The system according to claim 9, wherein said token cycles among said plurality of ports according to their predetermined priority from high to low.

14. The system according to claim 9, wherein said corresponding priority job item is a first received job item in said predetermined priority port.

15. The system according to claim 9, wherein said corresponding job item is a first received job item in said port.

16. The system according to claim 9, wherein said corresponding job item is processed by said robot while said corresponding priority job item exists.

17. The medium according to claim 5, wherein said corresponding job item includes an empty job item.
